(19) United States
(12) Patent Application Publication
(10) Pub. No.: US 2009/0045638 A1
(43) Pub. Date: Feb. 19, 2009

(54) METHOD OF MAKING A BUMPER STRUCTURE OF A MOTOR VEHICLE, AND BUMPER STRUCTURE

(75) Inventors: CHRISTIAN HANDING, Langenberg (DE); Oliver Muller, Paderborn (DE); Ludger Gehringhoff, Paderborn (DE)

Correspondence Address: Henry M. Feiereisen;Henry M. Feiereisen LLC, Suite 1501, 708 Third Avenue, New York, NY, 10017, US

(73) Assignee: Benteler Automobiltechnik GmbH, Paderborn (DE)

(21) Appl. No.: 12/191,636

(22) Filed: Aug. 14, 2008

(30) Foreign Application Priority Data
Aug. 14, 2007 (DE) 10 2007 038 496.5

(51) Int. Cl. B60R 19/04; B21D 53/88

(52) U.S. Cl. 293/155; 29/897.2

(57) ABSTRACT

In a method of making a bumper structure of a motor vehicle, a blank of quenched and tempered steel is formed into a U-shaped bumper beam having a middle part and attachment parts which adjoin the middle part on opposite ends and define crash boxes. The middle part of the bumper beam is hardened either during or after the blank is formed into the bumper beam.

### CROSS-REFERENCES TO RELATED APPLICATIONS

This application claims the priority of German Patent Application, Serial No. 10 2007 038 496.5, filed Aug. 14, 2007, pursuant to 35 U.S.C. 119(a)-(d), the content of which is incorporated herein by reference in its entirety as if fully set forth herein.

### BACKGROUND OF THE INVENTION

The present invention relates to a method of making a bumper structure of a motor vehicle, and to a bumper structure.

Nothing in the following discussion of the state of the art is to be construed as an admission of prior art.

A bumper structure is mounted to the front or rear of a motor vehicle to convert generated impact energy into deformation work, in the event of a frontal or rear impact with a road user or in the event of a collision with an obstacle, so as to prevent or minimize damage to vehicle components, in particular the chassis, and thus to limit the amount of damage. In addition, a bumper structure is provided to assist in the stiffening of the vehicle chassis. The bumper structure must satisfy regulations with respect to the low-speed test (up to 16 km/h) and represents an important part because of its immediate impact on the damage and damage assessment in the event of a crash of the motor vehicle and thus categorization in certain insurance classes. A decrease in damage costs improves the insurance categorization.

The bumper structure has a bumper beam which is linked to the side rails of the motor vehicle via crash boxes which extend between the side rails and the bumper beam or may also be a component of the side rail itself, in which case they are designed as repair solution. Crash boxes are normally screwed via flange plates to the side rails of the motor vehicle. The single components of the crash box, i.e. the crash box profile extending in travel direction and the flange plate are typically welded together. Welded connections are, however, prone to corrode because the material doubling caused by spot welding promotes corrosion.

It would therefore be desirable and advantageous to address this problem and to obviate other prior art shortcomings.

### SUMMARY OF THE INVENTION

According to one aspect of the present invention, a method of making a bumper structure of a motor vehicle includes the steps of forming a blank of quenched and tempered steel into a U-shaped bumper beam having a middle part and attachment parts which adjoin the middle part on opposite ends and define crash boxes, and hardening the middle part of the bumper beam. The hardening step may hereby be executed during or after the forming step.

As a result, there is no need for a welding operation to connect a crash box to the flange plate of a side rail or to the bumper beam. The crash box is a single-piece component of the blank from which the bumper beam is also fabricated so that the problem associated with spot welding and resultant corrosion is overcome by the reduction in structural parts.

As the bumper beam is of single-piece configuration, there are considerations that should be taken into account when dimensioning the crash box to suit various demands in the event of a crash. In order to allow high deformability in defined regions and high stiffness in other regions, alternative manufacturing methods are proposed for single-piece bumper beams.

According to one embodiment, the middle part of the bumper beam may undergo during or after forming of the blank a heat treatment and may be hardened in particular. Hardening may be realized through hot forming the steel blank using a forming tool in which the hardening operation takes place at the same time. Of course, the heat treatment and hardening steps may also be carried out separately after the forming operation.

The heat treatment in some regions of the steel blank causes areas of different strength and stiffness. In particular the attachment parts remain unhardened to exhibit a particular soft impact behavior. The structural part involved here is thus quenched and tempered only in some regions.

In addition to the general division in unhardened and impact-soft regions (attachment part), on one hand, and hardened and thus very firm and stiff regions (middle part), on the other hand, further differentiations may be implemented during heat treatment. A “hardened region”, such as the middle part, relates hereby to an area which is predominantly hardened and exhibits overall a higher strength and stiffness than a predominantly unhardened area. The term “predominantly” relates hereby to a range of more than 50%, in particular more than 70%, and in particular more than 90%. In other words, the hardened middle part may have small regions that remain unhardened. The same applies for the soft behavior of the attachment parts at impact.

According to another aspect of the present invention, a method of making a bumper structure of a motor vehicle includes the steps of providing several blanks of different wall thicknesses and/or material grades, welding the blanks to form a tailored welded blank, and forming the tailored welded blank into the shape of a U-shaped bumper beam having a middle part and attachment parts which adjoin the middle part on opposite ends and define crash boxes, such that the wall thickness and/or material grade in the middle part deviates from the wall thickness and/or material grade in the attachment parts.

A tailored welded blank is fabricated by butt welding single blanks so that many variations in material selection and wall thickness can be realized. The use of a tailored welded blank allows also configuring the attachment parts differently. For example, one of the attachment parts may be provided with a hole for a tow lug so that this attachment part exhibits a different deformation behavior than the other attachment part. Of course, it is also possible to select the material and wall thickness for the attachment parts such as to best suit the respective crash demands which do not necessarily have to be the same for both attachment parts or crash boxes.

According to yet another aspect of the present invention, a method of making a bumper structure of a motor vehicle includes the steps of forming a tailored rolled blank into a U-shaped bumper beam having a middle part and attachment parts which adjoin opposite ends of the middle part and define crash boxes, such that the middle part has a wall thickness which deviates from a wall thickness in the attachment parts.

A tailored rolled blank is a sheet metal strip which is rolled in such a manner as to have regions of different thicknesses. The tailored rolled blank exhibits an even transition between two thickness zones. In this way, it is possible to avoid the presence of sudden changes in strength between the middle part and the terminal attachment parts so that impact forces acting on the middle part can be deflected into the attachment parts without encountering stress peaks in the material. Of course the use of tailored rolled blanks also allows the implementation of different wall thicknesses in the attachment parts. The bumper structure thus does not necessarily have a symmetric configuration with respect to the selection of the wall thicknesses.

According to another feature of the present invention, the tailored rolled or tailored welded blanks may be made from quenched and tempered steel so that the blank shaped into the bumper structure can be hardened at least in its middle part. As a result, the benefits of different materials or wall thicknesses can be combined with the benefits of a targeted heat treatment of regions to create a bumper structure which is lightweight, corrosion-resistant, and inexpensively to make.

According to another feature of the present invention, the attachment parts may be hardened in such a manner that a region of the attachment parts remains unhardened. In this way, the mechanical resistance capability to changes in the structure can be decreased in a targeted manner to thereby simplify the plastic deformability so that the crash box yields in the event of a crash. As the bumper structure has a U-shaped cross section, the unhardened regions should be arranged in the substantially horizontal top flange and/or bottom flange.

Unhardened regions can be realized by heating these regions, while the formed blank is hardened within the forming tool, or to omit cooling of these targeted regions. As an alternative, it is also possible to heat the respective regions after removal of the bumper beam from the forming tool to locally reduce the strength. The higher the hardened regions are tempered, the greater the reduction in hardness while the toughness increases at the same time.

According to another feature of the present invention, several regions may be formed in succession transversely to a length extension of the bumper beam which remain unhardened or are heated for reducing a material strength in the regions, i.e. regions of reduced hardness and increased toughness. In this way, the attachment part can fold in a targeted manner.

In order to enable a defined deformation of the bumper beam in the area of the attachment parts, openings in the form of bores or oblong holes may be provided. Suitably, at least two oblong holes may be provided in the top flange and/or bottom flange in the area of the attachment parts and extend in longitudinal direction of the bumper beam and are arranged in succession in a direction transversely to a longitudinal extension of the bumper beam. Such a weakening of the cross section also results in the desired deformability in the area of the attachment part which serves as crash box in the bumper structure according to the invention.

The oblong holes may have different length and may be arranged offset to one another in longitudinal direction of the bumper beam. Several short oblong holes or openings may also be arranged side-by-side in longitudinal direction of the bumper beam, i.e. transversely to the longitudinal direction of the vehicle or impact direction, or arranged behind one another, when viewed in impact direction. The desired weakened areas of the structure cause a predictable deformation of the attachment parts. The preceding variation possibilities with respect to the arrangement of oblong holes/openings are applicable also for the regions of reduced hardness. The oblong holes can be provided already when the blank is cut to size which is then formed to the desired bumper beam.

In accordance with the invention, a bumper structure is realized which omits the use of separate crash boxes that need to be mounted separately so that the bumper structure according to the invention can be secured directly to the side rails of the motor vehicle. The geometric changes or alterations of the structure to influence the stiffness allow the combination of resistant, rigid middle parts of the bumper beam with impact-soft, i.e. yielding, attachment parts which serve as crash boxes and can be realized inexpensively as a result of the production method according to the invention.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a perspective view of a first embodiment of a bumper structure according to the present invention;

FIG. 2 is a perspective view of a second embodiment of a bumper structure according to the present invention;

FIG. 3 is a perspective view of a third embodiment of a bumper structure according to the present invention;

FIG. 4 is a plan view of an attachment part of a bumper structure; and

FIG. 5 is a plan view of a variation of an attachment part of a bumper structure.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

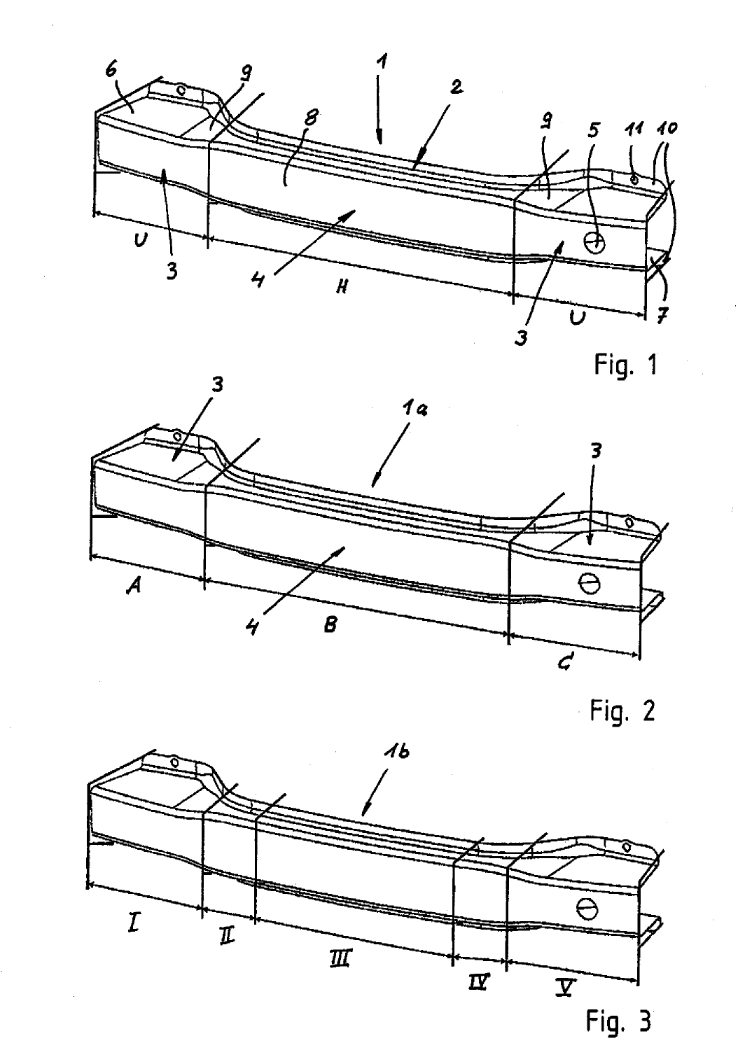

Turning now to the drawing, and in particular to FIG. 1, there is shown a perspective view of a first embodiment of a bumper structure according to the present invention, generally designated by reference numeral 1 for an unillustrated motor vehicle. The bumper structure 1 is made from a blank of quenched and tempered steel and formed to have a profiled U-shaped cross section. The bumper structure 1 includes two functional components, namely a bumper beam 2 and crash boxes formed in one piece with the bumper beam 2. The crash boxes are hereby formed by terminal attachment parts 3 by the bumper beam 2 is mounted to the side rails of the motor vehicle. The area between the attachment parts 3 is referred to as middle part 4.

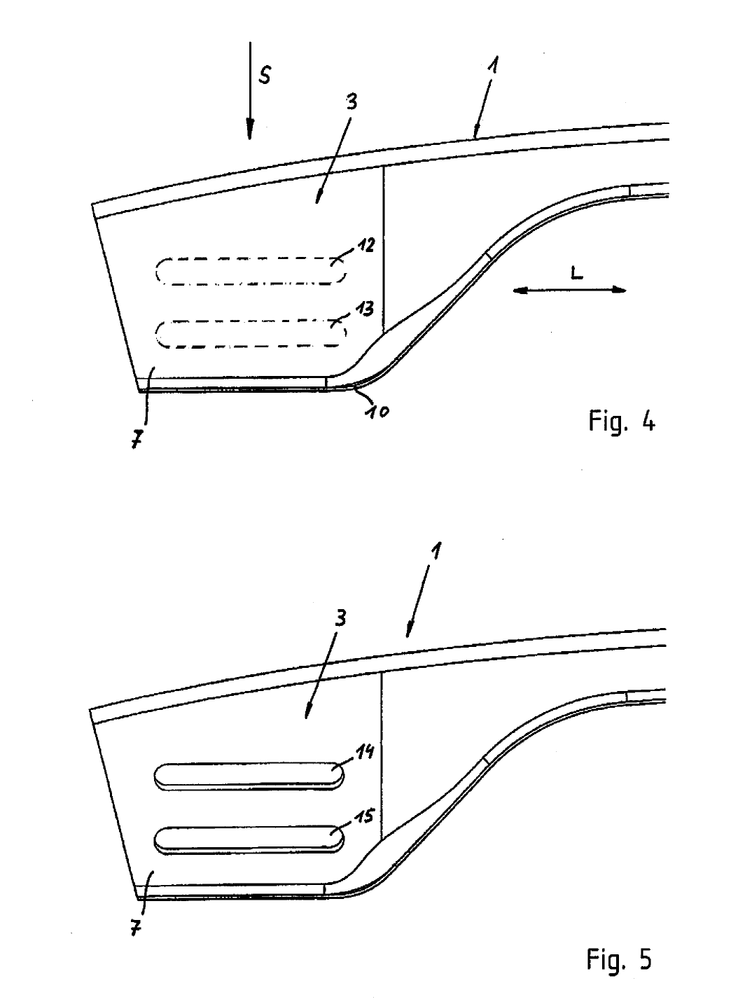

The U-shaped bumper beam 2 points with its open side in the direction of the side rails which are not shown in detail. As a result, the bumper beam 2 has a closed front side, except for an opening 5 for feedthrough of a tow lug in the attachment part 3 to the right in the drawing plane. A top flange 6, which is oriented in substantially horizontal direction when installed, and a bottom flange 7 extend in substantial parallel relationship and interconnected by a front wall. The distance between top flange 6 and bottom flange 7 and thus the width of the wall B vary over the length extension of the bumper structure 1. In particular the width of the wall 8, measured in vertical direction decreases to the ends so that the distance between top flange 6 and bottom flange 7 is smaller in the area of the attachment parts 3 than in the area of the middle part 4. The change in distance is not sudden but gradual within transition zones 9. The distance between top flange 6 and bottom flange 7 is, however, constant again in the middle part 4 and the attachment parts 3. The transition zones 9 are also characterized by an increase in depth of the U-shaped bumper beam 2. As a result, the width of the top flange 6 and the bottom flange 7 is at a maximum in the attachment parts 3 which form the crash boxes. This is especially shown in FIGS. 4 and 5. The reason for that is the need for a sufficient deformation path in the area of the attachment parts 3, whereas the resultant material accumulation is required in the middle part 4 so that the width of the top flange 6 and the bottom flange 7 can be significantly smaller in the middle part 4.

FIGS. 1-3 further show that the wall-distal ends of the top flange 6 and the bottom flange 7 have flanged collars 10 pointing outwardly in opposite directions for securement of the bumper structure 1 to the unillustrated side rails. The securement of the bumper structure 1 to the side rails may be realized in particular via at least one bore 11 in the flanged collar 10 on the top flange side and bottom flange side.

The bumper beam 2 of the bumper structure 1, shown in FIG. 1, is made in one piece with the attachment parts 3 that form the crash boxes, with the middle part 4 and the attachment parts 3 having different material properties. Reference character “H” designates the area that has been hardened, i.e. the middle part 4, while reference character “U” designates the areas that remain unhardened, i.e. the attachment parts 3. As a result, the bumper structure 1 has different material properties along its length extension so as to have attachment parts 3 of low flexural strength and a rigid middle part 4.

Referring now to FIG. 2, there is shown a second embodiment of a bumper structure according to the present invention, generally designated by reference sign 1a. Parts corresponding with those in FIG. 1 are denoted by identical reference numerals and not explained again. The description below will center on the differences between the embodiments. In this embodiment, the bumper structure 1a is made of a blank which has areas of different wall thicknesses and/or different material grade. The blank used for making the bumper structure 1a is a tailored welded blank which is configured such that a steel A is used for making the area of the attachment part 3 to the left of the drawing plane, whereas the middle part 4 is made of a steel B and the attachment part 3 to the right of the drawing plane is made of a steel C. The areas across which the individual steels extend are characterized by the reference signs A, B, C. The steels A, B, C stand for different material grades as well as for different wall thicknesses so that the use of tailored welded blanks enables the realization of a bumper structure that can be best suited to the demand at hand.

FIG. 3 shows a third embodiment of a bumper structure according to the present invention, generally designated by reference sign 1b and made from a tailored rolled blank. The bumper structure 1b differs from the bumper structure 1a by differences in wall thickness which are less sudden. Moreover, the tailored roll blank is made of a single material having thickness areas designated by Roman numerals I, II, III, IV, V. It is conceivable to provide the areas I and V of same wall thickness. Of course, deviations between all wall thickness areas as well as additional heat treatments are possible to best suit the bumper structure 1b to the demands in the event of a crash.

FIG. 4 shows a plan view of a detail of the bumper structure 1, depicting in particular an attachment part 3 which is hardened except for the regions 12, 13 shown in broken line. The regions 12, 13 have been disregarded during the hardening process or underwent a heat treatment to reduce the strength again. The unhardened or heated regions 12, 13 extend transversely to the length extension L of the bumper structure 1 so as to attain a targeted folding of the attachment part 3 in direction of the impact direction, indicated by arrow S and thus effect a desired deformation.

FIG. 5 shows a plan view of a variation of an attachment part 3 of the bumper structure 1 which has also weakened areas in the top flange 7 in length direction L of the bumper beam 2. This embodiment differs from the one shown in FIG. 4 by the provision of weakened areas in the form of oblong holes 14, 15 which have a same effect as the regions 12, 13 so as to reduce the stiffness of the attachment part 3 and thus to improve the plastic deformability.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

1. A method of making a bumper structure of a motor vehicle, comprising the steps of:
forming a blank of quenched and tempered steel into a U-shaped bumper beam having a middle part and attachment parts which adjoin the middle part on opposite ends and define crash boxes; and
hardening the middle part of the bumper beam.

2. The method of claim 1, wherein the hardening step is executed during the forming step.

3. The method of claim 1, wherein the hardening step is executed after the forming step.

4. The method of claim 1, wherein the attachment parts have a substantially horizontal top flange and a substantially horizontal bottom flange, further comprising the step of hardening the attachment parts such that a region of at least one of the top and bottom flanges remains unhardened.

5. The method of claim 1, wherein the attachment parts have a substantially horizontal top flange and a substantially horizontal bottom flange, further comprising the steps of hardening the attachment parts and heating a region of at least one of the top and bottom flanges for reducing a material strength in the region.

6. The method of claim 1, wherein the attachment parts have a substantially horizontal top flange and a substantially horizontal bottom flange, further comprising the steps of hardening the attachment parts such that several regions are formed in succession transversely to a length extension of the bumper beam and remain unhardened or are heated for reducing a material strength in the regions.

7. The method of claim 1, wherein the attachment parts have a substantially horizontal top flange and a substantially horizontal bottom flange, further comprising the step of forming at least in one of the top and bottom flanges in an area of the attachment parts at least two oblong holes extending in longitudinal direction of the bumper beam and arranged in succession in a direction transversely to a longitudinal extension of the bumper beam.

8. The method of claim 7, wherein the oblong holes are formed before the blank is shaped into the bumper beam.

9. A method of making a bumper structure of a motor vehicle, comprising the steps of:
providing several blanks of different material properties;
welding the blanks to form a tailored welded blank; and
forming the tailored welded blank into the shape of a U-shaped bumper beam having a middle part and attachment parts which adjoin the middle part on opposite ends and define crash boxes, such that the material property in the middle part deviates from the material property in the attachment parts.

10. The method of claim 9, wherein the material property is selected from the group consisting of wall thickness and material grade.

11. The method of claim 9, wherein one of the blanks is made of quenched and tempered steel, and further comprising the step of hardening the tailored welded blank at least in the middle part.

12. The method of claim 9, wherein the attachment parts have a substantially horizontal top flange and a substantially horizontal bottom flange, further comprising the step of hardening the attachment parts such that a region of at least one of the top and bottom flanges remains unhardened.

13. The method of claim 9, wherein the attachment parts have a substantially horizontal top flange and a substantially horizontal bottom flange, further comprising the steps of hardening the attachment parts and heating a region of at least one of the top and bottom flanges for reducing a material strength in the region.

14. The method of claim 9, wherein the attachment parts have a substantially horizontal top flange and a substantially horizontal bottom flange, further comprising the steps of hardening the attachment parts such that several regions are formed in succession transversely to a length extension of the bumper beam and remain unhardened or are heated for reducing a material strength in the regions.

15. The method of claim 9, wherein the attachment parts have a substantially horizontal top flange and a substantially horizontal bottom flange, further comprising the step of forming at least in one of the top and bottom flanges in an area of the attachment parts at least two oblong holes extending in longitudinal direction of the bumper beam and arranged in succession in a direction transversely to a longitudinal extension of the bumper beam.

16. The method of claim 15, wherein the oblong holes are formed before the blank is shaped into the bumper beam.

17. A method of making a bumper structure of a motor vehicle, comprising the steps of forming a tailored rolled blank into a U-shaped bumper beam having a middle part and attachment parts which adjoin opposite ends of the middle part and define crash boxes, such that the middle part has a wall thickness which deviates from a wall thickness in the attachment parts.

18. The method of claim 17, wherein the tailored rolled blank is made of quenched and tempered steel, and further comprising the step of hardening the tailored rolled blank at least in the middle part.

19. The method of claim 17, wherein the attachment parts have a substantially horizontal top flange and a substantially horizontal bottom flange, further comprising the step of hardening the attachment parts such that a region of at least one of the top and bottom flanges remains unhardened.

20. The method of claim 17, wherein the attachment parts have a substantially horizontal top flange and a substantially horizontal bottom flange, further comprising the steps of hardening the attachment parts and heating a region of at least one of the top and bottom flanges for reducing a material strength in the region.

21. The method of claim 17, wherein the attachment parts have a substantially horizontal top flange and a substantially horizontal bottom flange, further comprising the steps of hardening the attachment parts such that several regions are formed in succession transversely to a length extension of the bumper beam and remain unhardened or are heated for reducing a material strength in the regions.

22. The method of claim 17, wherein the attachment parts have a substantially horizontal top flange and a substantially horizontal bottom flange, further comprising the step of forming at least in one of the upper and bottom flanges in an area of the attachment parts at least two oblong holes extending in longitudinal direction of the bumper beam and arranged in succession in a direction transversely to a longitudinal extension of the bumper beam.

23. The method of claim 22, wherein the oblong holes are formed before the blank is shaped into the bumper beam.

24. A bumper structure, comprising a bumper beam made of quenched and tempered steel and having a U-shaped configuration, said bumper beam having a middle part and attachment parts which adjoin the middle part on opposite ends and define crash boxes, wherein the middle part of the bumper beam has a material strength which is greater than a material strength of the attachment parts.
